(19) United States
(12) Patent Application Publication
(10) Pub. No.: US 2001/0032140 A1
(43) Pub. Date: Oct. 18, 2001

(54) Virtual sales agent

(76) Inventor: Roger P. Hoffman, Green Bay, WI (US)

Correspondence Address: Philip M. Weiss, Weiss & Weiss, Suite 305, 500 Old Country Road, Garden City, NY, 11530, US

(21) Appl. No.: 09/736,036

(22) Filed: Dec. 13, 2000

Related U.S. Application Data
(60) Provisional application No. 60/170,643, filed on Dec. 14, 1999.
(60) Provisional application No. 60/202,992, filed on May 9, 2000.

(51) Int. Cl. G06F 17/60

(52) U.S. Cl. 705/26

(57) ABSTRACT

The present invention relates to a system and a method for performing sales transactions using a virtual sales agent.

### FIELD OF THE INVENTION

The present invention relates to a system and a method for performing sales transactions using a virtual sales agent.

### BACKGROUND OF THE INVENTION

Presently there are no methods of personalizing transactions on the Internet. When a person or business orders an item on the Internet for purchase they are usually directed to a catalog. Some of these systems offer a help desk where a consumer can contact a person by telephone off line and be assisted in making their purchase.

Present e-commerce models are not personal, there is no relationship with an e-commerce person. It is very easy to say no to a computer screen. But the e-commerce model is cheap for customer contacts. A sales person is effective, but costly, whereas the Internet is cheap, but not personal. There is not stickiness with a computer screen in the present sales transaction.

Most salesmen do not appreciate the Internet. They see the Internet as replacing them. There is no current system on the Internet, which uses the contacts and the relationships that have been developed between the salesmen and their customers.

### SUMMARY OF THE INVENTION

The present invention relates to a system and a method for performing sales transactions. The present invention relates to a system for performing sales transactions online comprising; a database, the database containing a profile of various sales agents. The database further contains information about each user. The database can communicate with the user either orally or in writing. It is a further object of the present invention that the sales agent comprises a three dimensional representation of a sales agent. It is a further object of the present invention that the information comprise information about a user's personal life, and information about a user's business activities.

It is a further object of the present invention that the database records each sales transaction completed. It is an object of the present invention that the profile of each sales agent comprises physical characteristics of the sales agent and/or educational history, and/or business style. It is an object of the present invention that the database can communicate with the user via e-mail, a web site, palm pilot, cell phone, or other wireless means.

The present invention relates to a method for performing sales transactions online comprising; logging into a database. The user then enters a password or other information that can be identified by said database. The user then chooses a virtual sales agent from the database by either entering characteristics of a sales agent into said database or clicking on a virtual sales agent provided by the database. The user then provides information to the virtual sales agent about a product or service a user wants to purchase.

The present invention further relates to a method of performing a sales transaction online comprising; providing information to a user concerning the user's personal life. The system then provides information to the user concerning past business transactions. The system then provides information to a user comprising price quality or quantity information for products for sale. The system then can assist the user in purchasing the products. It is an object of the present invention to provide the information via e-mail, a web site, palm pilot, cell phone, or other wireless means.

It is an object of the invention to provide a system that responds to a request for information from a business or consumer either by voice or in writing. It is an object of the present invention that if the response is oral, that the voice be of a person, who is the customer's off line sales agent who is familiar with one of his/her accounts.

It is a further object of the invention to have a three dimensional representation of a person conduct the transaction over the Internet.

A sales representative who has been selling products to an individual or a company best knows how to sell the customer that they are selling through the relationship they have built with the customer.

It is an object of the present invention to store all of the knowledge of a sales person concerning their accounts or customers onto a database. It is an object of the present invention to store information concerning a client's personal life, including information about their family, hobbies, where they live, sports teams they like, etc. into a database. It is a further object of the present invention for the salesmen to input the business activities of their clients into the database.

It is an object of the invention for the database to store information concerning the number of sales that are made over the Internet by each sales agent. This information can assist other salesmen in preparing their virtual sales techniques. In this way the database can continually learn and change the sales technique to the most preferred technique.

It is an object of the present invention to allow a consumer or business to identify the type of qualities that they are looking for in a sales agent, and therefore choose the type of sales agent they would like to deal with. Or based on the qualities listed by the user, the system of the present invention can match a sales agent to the user. It is an object of the present invention to provide a variety of virtual sales agents to the user, each having different qualities and characteristics. The type of qualities could be physical, such as whether the sales agent is a man or woman, or virtual sales agents of varying age. The qualities of the virtual sales agent also depend on their selling technique, such as whether the sales agent is nurturing or whether they take risks.

It is an object of the present invention to provide a picture and/or a resume of each virtual sales agent. It is a further object of the present invention to provide a video stream of the virtual sales agent.

It is an object of the present invention to allow salesmen to increase their number of sales by being available to clients and providing information to clients through the system of the present invention, without having direct contact with the client.

### DETAILED DESCRIPTION OF THE INVENTION

In one embodiment, the system of the present invention can be used with salesmen who are selling to their business accounts over the Internet. A salesmen inputs information into the database concerning their accounts. Information includes, personal information, such as information about the client's family, sports teams and hobbies. The database is then provided with information concerning the client's business activities, including the types of purchases the client has made in the past, the sales range of the goods or services the client is purchasing, information on delivery, shipping, billing information, and other information that the salesmen has regarding the client's past sales transactions.

For example, a client logs into the database of the present invention. Based on the information inputted into the database by the user, such as a password or other information identifying the user, the user is directed to their virtual sales agent. The database then accesses the information, which was stored in the database about this user by the sales agent. If the user is a new user, who does not have a virtual sales agent, that scenario will be discussed below. The database of the present invention determines where the user is logging in from through their IP address. The system can say to the user, either orally or in writing, good morning or good afternoon based on the time where the user is logging in from.

Based on information on where a person logs into the Internet, the virtual sales agent can ask about the weather in a specific area, or the database can be connected to weather information so as to provide the weather information to the user. If the sales agent provided information about the user's interests in sports teams, the system of the present invention can provide information about the user's sports team. This information can be taken off the Internet. Also the virtual sales agent can discuss with the user about their family or any specific information that the sales agent provided to the database about their customer.

The virtual sales agent can then proceed to conduct business with the client. The virtual sales agent can then discuss the past orders that have been placed by the client. The virtual sales agent can discuss whether orders have been received and about the quality of the goods and services. The virtual agent stores all of the information received from the user. Once a user places an order with the system of the present invention, the system stores that information, and the next time that user is online, the virtual sales agent can provide information about the status of that order. The first time through the database the virtual sales agent will explain to the user how the system works.

In an embodiment of the present invention, the virtual sales agent will be able to provide up to date price, quality and quantity information since the information is constantly being updated by the company who is selling the goods or services. The virtual sales agent will be able to provide special opportunities to the user, such as, a sale, new product, etc. The second time or any further time that a user communicates with the virtual sales agent a different program or response then the first time will be received by the user. The virtual sales agent will record the information received by the first communication and will then program the next communication according to what was discussed the first time.

In a preferred embodiment the information is provided by voice but other means such as having the information provided in writing by the virtual sales agent is also covered by the present invention.

The information that is inputted into the database by the user can then be retrieved by the actual sales agent who provided the information about the customer. This information can be password protected. The sales agent can then enter information into the database after reviewing the submissions from the user.

Sales persons can be trained about the best sales techniques for selling over the Internet. Once the techniques have been established by each virtual sales agent, the best techniques can be incorporated into the other virtual sales agents based on the number of sales made by each virtual sales agent. Sales techniques are modified for each virtual sales agent to improve stickiness. E-mails can be done by voice through an actual sales agent. A user can contact an actual sales representative through the site.

An actual sales transaction can be done through a virtual sales agent on the Internet. Commissions can be calculated for sales made by the virtual sales agents. The system of the present invention can also offer a virtual credit card.

The present invention can be used with Business to Business transactions, stockbroker transactions, insurance transactions, attorney, doctor, grocer, tailor or other clothing, and any other sales transactions.

In a further example, the virtual sales agent can be used by a individual user looking to transact business, such as the purchase of stock. An individual uses the system of the present invention to purchase stock. First a user chooses their virtual sales agent. The user can request a male or female, select approximate ages, make a selection based on educational background, job history and any other factors that go into determining the qualities of the virtual sales agent for this profession.

In an alternative embodiment, the system of the present invention can provide resumes, pictures or other information concerning the virtual sales agent for the user to choose from.

In this embodiment where the virtual sales agent is a virtual stock broker the sales agent can perform all stock transactions, answer any questions based on the information that is provided to them by the actual stock broker who inputs the information which is required by the user.

Virtual sales agents can be used for any sales transaction that can be done over the Internet. In a preferred embodiment the virtual sales agent works best for repeat customers

1. A system for performing sales transactions online comprising;
a database;
said database containing of a profile of various sales agents;
said database containing of information about each user;
said database being capable of communicating with said user either orally or in writing.

2. The system of claim 1 wherein said sales agent comprises a three dimensional representation of a sales agent.

3. The system of claim 1 wherein said information comprises information about a user's personal life, and information about a user's business activities.

4. The system of claim 1 wherein said database records each sales transaction completed.

5. The system of claim 1 wherein said profile comprises physical characteristics of said sales agent and/or educational history, and/or business style.

6. The system of claim 1 wherein said communication can be via e-mail, a web site, palm pilot, cell phone, or other wireless means.

7. A method for performing sales transactions online comprising;
logging into a database;
entering a password or other information that can be identified by said database;
choosing a virtual sales agent from the database by either entering characteristics of a sales agent into said database or clicking on a virtual sales agent provided by said database;
providing information to said virtual sales agent about a product or service a user wants to purchase.

8. A method of performing a sales transaction online comprising;
providing information to a user concerning the user's personal life;
providing information to said user concerning past business transactions;
providing information to a user comprising price quality or quantity information for products for sale.

9. The method of claim 8 wherein said information is provided via e-mail, a web site, palm pilot, cell phone, or other wireless means.
